(19) United States
(12) Patent Application Publication
(10) Pub. No.: US 2008/0039175 A1
(43) Pub. Date: Feb. 14, 2008

(54) Multiple independent games within games

(76) Inventors: Michael Thomas Tessmer, Denhan Springs, LA (US); Alan Douglas Williams, Las Vegas, NV (US)

Correspondence Address: MTD Gaming, Inc., 2737 Timberchase Trail, Littleton, CO, 80126-5527, US

(21) Appl. No.: 11/498,591

(22) Filed: Aug. 3, 2006

(51) Int. Cl. A63F 13/00

(52) U.S. Cl. 463/20

(57) ABSTRACT

A gaming device with multiple independent games. Each independent game has its own pay table independent of other additional games. Combined sets of independent games also have independent pay tables. In one embodiment, one independent game is threes reels on a five reel video slot machine and another independent game is four reels on the same five reel video slot machine. In another embodiment, pay lines of different length and location represent an independent game. A wager made by the player in any of the independent games is separate from a wager in other independent games.

### CROSS-REFERENCE TO RELATED APPLICATION

This application claims priority to the following U.S. Provisional Patent Application: Ser. No. 60/685,925, filed on Aug. 5, 2005 and entitled “Primary Game with Additional Independent Games,” which is incorporated herein by reference.

### COPYRIGHT NOTICE

A portion of the disclosure of this patent document contains material which is subject to copyright protection. The copyright owner has no objection to the photocopy reproduction by anyone of the patent document or the patent disclosure in exactly the form it appears in the Patent and Trademark Office patent file or records, but otherwise reserves all copyright rights whatsoever.

### DESCRIPTION

The present invention relates in general to a gaming device and more particularly to a gaming device having one or more independent games independent of the primary game and which the independent games are a subset or superset of another independent game. Independent games may be combined into a set of games. Players may wager on the appearance of winning combinations in any or all of the independent game or games, combinations of independent games and combinations of sets of games.

### BACKGROUND OF THE INVENTION

Gaming machine manufacturers constantly strive to produce gaming machines that maximize enjoyment and excitement for players by incorporating familiar features in various ways in the games. Known gaming devices include triggering events which occur during the play of the primary game of the gaming device. The triggering event temporarily stalls or halts the base game play and enables the player to enter a second, different type of game, which is the bonus game. The player plays one type of game in the bonus game, likely receives an award in the bonus game, and returns to the base game. The base game is fixed in its structure and the bonus game is separate and distinct from the base game. There is, therefore, a need to provide a means of allowing multiple games within the base game as an extension of the base game to enhance the enjoyment and excitement of players within the base game environment.

Reel games are also well-known types of games. It is well known that a plurality of reels can be employed in a bonus game as well as a base game. Reels in gaming devices are known to have a variety of different types of symbols, indicia or characters displayed on the reels. Awards are typically associated with one or more symbols, and one or more combinations of symbols.

Gaming device manufacturers have also made games where the maximum wager in the base game influences an outcome in a bonus game. An example of a method in which a wager in the base game is able to affect an outcome in the bonus game is disclosed in U.S. Pat. No. 6,186,894 (Mayeroff) in which in one embodiment the number of chances provided to the player to play the secondary event game is based on the number of pay lines that the player has played on the main game or by the number of credits wagered on each pay line.

There is a continuing need to provide new and different games for wagering gaming machines.

### SUMMARY OF THE INVENTION

The present invention relates generally to a gaming device wherein an additional game independent of the first game is a superset or subset of the first game with its own specific pay table.

In one embodiment of the present invention, the gaming device provides at least two different ways of simultaneously placing a wager on two or more games that are independent games within the combined game set. In one embodiment, the gaming device includes an independent game operable upon a wager by a player and an additional independent game. At least one primary award is adapted to be provided to the player in the first independent game. The additional independent game includes at least one different feature or type of features or functions. The additional independent game includes a plurality of different independent game awards adapted to be provided to the player based on the independent wager. It should be appreciated that the features or types of features or functions of an independent game in the base game can be any suitable feature or function in the game if the player makes a designated wager.

In one embodiment which includes player-selectable selections, the wager made by a player in the first game determines the number of picks of the selections provided to the player as well as the outcomes associated with at least one and preferably a plurality of the selections in an independent game.

It is therefore an advantage of the present invention to provide a gaming device which provides additional independent types of games in conjunction with the first independent game.

Additional features and advantages of the present invention are described in, and will be apparent from, the following Detailed Description of the Invention and the figures.

### BRIEF DESCRIPTION OF THE FIGURES

FIG. 1 is a front prospective view of one embodiment of the gaming device of the present invention.

FIG. 2 is a schematic block diagram of the electronic configuration of one embodiment of the gaming device of the present invention.

FIG. 3 is a schematic block diagram of the central determination embodiment of the gaming device of the present invention

FIG. 4 is a schematic block diagram of the first game

FIG. 5 is a schematic block diagram of an additional independent game

FIG. 6 is a schematic block diagram of another additional independent game

FIG. 7 is a schematic block diagram of multiple independent games in one game set.

### DETAILED DESCRIPTION OF THE INVENTION

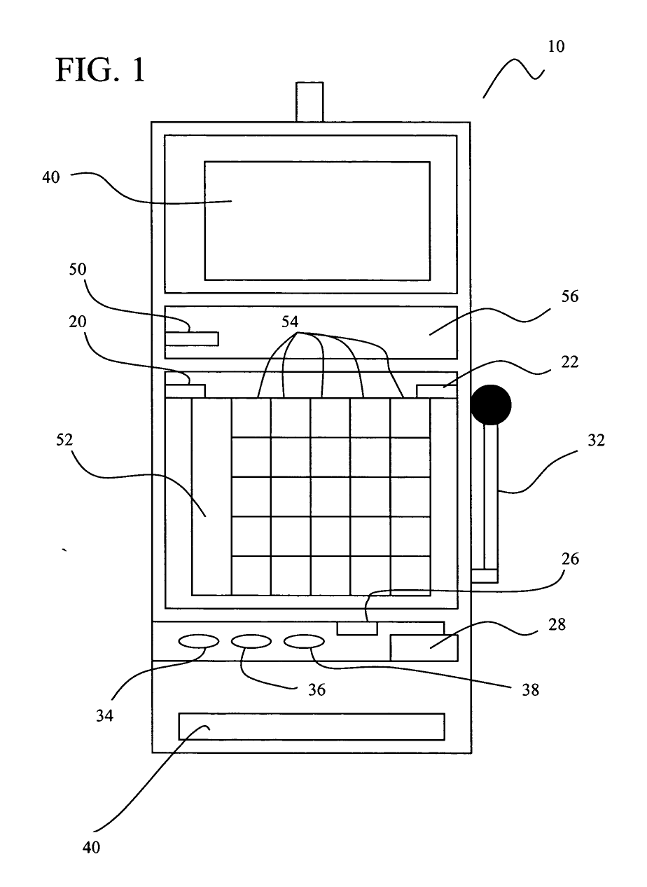

Referring now to the drawings, an embodiment of the gaming device of the present invention illustrated in FIG. 1 generally referred to herein as gaming device 10.

In one embodiment, as illustrated in FIG. 1, gaming device 10 has a support structure, housing or cabinet which provides support for a plurality of displays, inputs, controls and other features of a conventional gaming machine. It is configured so that a player can operate it while standing or sitting. The gaming device may be positioned on a base or stand or can be configured as a pub-style table-top game (not shown) which a player can operate preferably while sitting. The gaming device can be constructed with varying cabinet and display configurations in addition to the configuration show in FIG. 1.

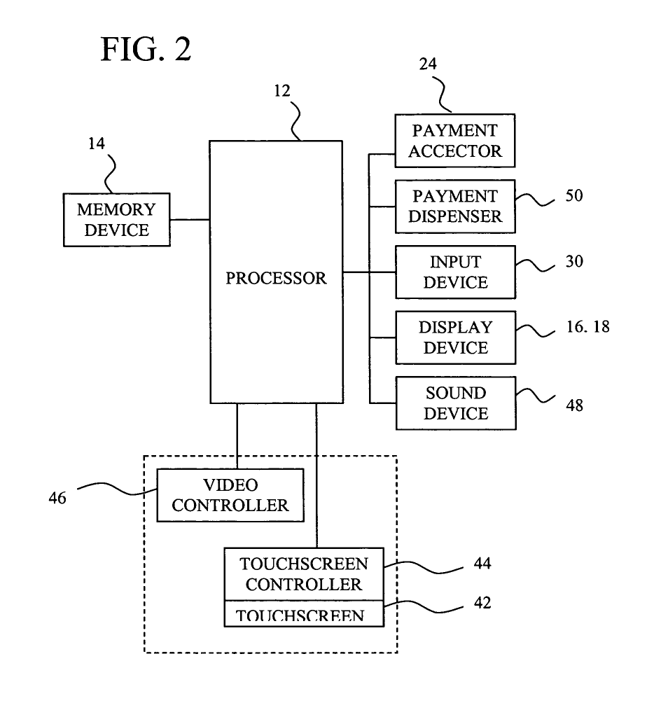

In one embodiment, as illustrated in FIG. 2, the gaming device preferably includes at least one processor 12, such as a microprocessor, a microcontroller-based platform, a suitable integrated circuit or one or more application-specific integrated circuits (ASIC's). The processor is in communication with or operable to access or to exchange signals with at least one data storage or memory device 14. In one embodiment, the processor and the memory device reside within the cabinet of the gaming device. The memory device stores program code and instructions, executable by the processor, to control the gaming device. The memory device also stores other data such as image data, event data, player input data, random or pseudo-random number generators, pay-table data or information and applicable game rules that relate to the play of the gaming device. In one embodiment, the memory device includes random access memory (RAM). In one embodiment, the memory device includes read only memory (ROM). In one embodiment, the memory device includes flash memory and/or EEPROM (electrically erasable programmable read only memory). Any other suitable magnetic, optical and/or semiconductor memory may be implemented in conjunction with the gaming device of the present invention.

In one embodiment, part or all of the program code and/or operating data described above can be stored in a detachable or removable memory device, including, but not limited to, a suitable cartridge, disk or CD ROM. A player can use such a removable memory device in a desktop, a laptop personal computer, a personal digital assistant (PDA) or other computerized platform. The processor and memory device may be collectively referred to herein as a “computer” or “controller.”

In one embodiment, as discussed in more detail below, the gaming device randomly generates awards and/or other game outcomes based on probability data. That is, each award or other game outcome is associated with a probability and the gaming device generates the award or other game outcome to be provided to the player based on the associated probabilities. In this embodiment, since the gaming device generates outcomes randomly or based upon a probability calculation, there is no certainty that the gaming device will ever provide the player with any specific award or other game outcome.

In another embodiment the gaming device employs a predetermined or finite set or pool of awards or other game outcomes. In this embodiment, as each award or other game outcome is provided to the player, the gaming device removes the provided award or other game outcome from the predetermined set or pool. Once removed from the set or pool, the specific provided award or other game outcome cannot be provided to the player again. This type of gaming device provides players with all of the available awards or other game outcomes over the course of the play cycle and guarantees the amount of actual wins and losses.

In one embodiment, as illustrated in FIG. 2, the gaming device includes one or more display devices controlled by the processor. The display devices are preferably connected to or mounted to the cabinet of the gaming device. The embodiment shown in FIG. 1 includes a central display device 16 which displays a primary game. This display device may also display any secondary game associated with the primary game as well as information relating to the primary or secondary game. As seen in FIG. 1, in one embodiment, gaming device includes a credit display 20 which displays a player's current number of credits, cash, account balance or the equivalent. In one embodiment, gaming device includes a bet display 22 which displays a player's amount wagered.

The display devices may include, without limitation, a monitor, a television display, a plasma display, a liquid crystal display (LCD) a display based on light emitting diodes (LED) or any other suitable electronic device or display mechanism. In one embodiment, as described in more detail below, the display device includes a touch-screen with an associated touch-screen controller. The display devices may be of any suitable configuration, such as a square, rectangle, elongated rectangle.

The display devices of the gaming device are configured to display at least one and preferably a plurality of game or other suitable images, symbols and indicia such as any visual representation or exhibition of the movement of objects such as mechanical, virtual or video reels and wheels, dynamic lighting, video images, images of people, characters, places, things and faces of cards, tournament advertisements and the like.

In one alternative embodiment, the symbols, images and indicia displayed on or of the display device may be in mechanical form. That is, the display device may include any electromechanical device, such as one or more mechanical objects, such as one or more rotatable wheels, reels or dice, configured to display at least one and preferably a plurality of game or other suitable images, symbols or indicia.

As illustrated in FIG. 2, in one embodiment, the gaming device includes at least one payment acceptor 24 in communication with the processor. As seen in FIGS. 1, the payment acceptor may include a coin slot 26 and a payment, note or bill acceptor 28, where the player inserts money, coins or tokens. The player can place coins in the coin slot or paper money, ticket or voucher into the payment, note or bill acceptor. In other embodiments, devices such as readers or validators for credit cards, debit cards or credit slips could be used for accepting payment. In one embodiment, a player may insert an identification card into a card reader of the gaming device. In one embodiment, the identification card is a smart card having a programmed microchip or a magnetic strip coded with a player's identification, credit totals and other relevant information. In one embodiment, money may be transferred to a gaming device through electronic funds transfer. When a player funds the gaming device, the processor determines the amount of funds entered and the corresponding amount is shown on the credit or other suitable display as described above.

As seen in FIGS. 1 and 2, in one embodiment the gaming device includes at least one and preferably a plurality of input devices 30 in communication with the processor. The input devices can include any suitable device which enables the player to produce an input signal which is read by the processor. In one embodiment, after appropriate funding of the gaming device, the input device is a game activation device, such as a pull arm 32 or a play button 34 which is used by the player to start any primary game or sequence of events in the gaming device. The play button can be any suitable play activator such as a bet one button, a max bet button or a repeat the bet button. In one embodiment, upon appropriate funding, the gaming device begins the game play automatically. In another embodiment, upon the player engaging one of the play buttons, the gaming device automatically activates game play.

In one embodiment, as shown in FIG. 1, one input device is a bet one button 36. The player places a bet by pushing the bet one button. The player can increase the bet by one credit each time the player pushes the bet one button. When the player pushes the bet one button, the number of credits shown in the credit display preferably decreases by one, and the number of credits shown in the bet display preferably increases by one. In another embodiment, one input device is a bet max button (not shown) which enables the player to bet the maximum wager permitted for a game of the gaming device.

In one embodiment, one input device is a cash out button 38. The player may push the cash out button and cash out to receive a cash payment or other suitable form of payment corresponding to the number of remaining credits. In one embodiment, when the player cashes out, the player receives the coins or tokens in a coin payout tray 40. In one embodiment, when the player cashes out, the player may receive other payout mechanisms 50 such as tickets or credit slips redeemable by a cashier or funding to the player's electronically recordable identification card.

In one embodiment, as mentioned above and seen in FIG. 2, one input device is a touch-screen 42 coupled with a touch-screen controller 44, or some other touch-sensitive display overlay to allow for player interaction with the images on the display. The touch-screen and the touch-screen controller are connected to a video controller 46. A player can make decisions and input signals into the gaming device by touching touch-screen at the appropriate places.

The gaming device may further include a plurality of communication ports for enabling communication of the processor with external peripherals, such as external video sources, expansion buses, game or other displays, an SCSI port or a key pad.

In one embodiment, as seen in FIG. 2, the gaming device includes a sound generating device controlled by one or more sounds device 48 which function in conjunction with the processor. In one embodiment, the sound generating device includes at least one and preferably a plurality of speakers or other sound generating hardware and/or software for generating sounds, such as playing music for the primary and/or secondary game or for other modes of the gaming device, such as an attract mode. In one embodiment, the gaming device provides dynamic sounds coupled with attractive multimedia images displayed on one or more of the display devices to provide an audio-visual representation or to otherwise display full-motion video with sound to attract players to the gaming device. During idle periods, the gaming device may display a sequence of audio and/or visual attraction messages to attract potential players to the gaming device. The videos may also be customized for or to provide any appropriate information.

In one embodiment, the gaming machine may include a player or other sensor, such as a camera in communication with the processor (and possibly controlled by the processor) that is selectively positioned to acquire an image of a player actively using the gaming device and/or the surrounding area of the gaming device. In one embodiment, the camera may be configured to selectively acquire still or moving (e.g., video) images and may be configured to acquire the images in either an analog, digital or other suitable format. The display devices may be configured to display the image acquired by the camera as well as display the visible manifestation of the game in split screen or picture-in-picture fashion. For example, the camera may acquire an image of the player and that image can be incorporated into the primary and/or secondary game as a game image, symbol or indicia.

Gaming device 10 can incorporate any suitable wagering primary or base game and additional independent games. The gaming machine or device of the present invention may include some or all of the features of conventional gaming machines or devices. The primary or base game may comprise any suitable reel-type game, card game, number game or other game of chance susceptible to representation in an electronic or electromechanical form which produces a random outcome based on probability data upon activation from a wager. That is, different primary wagering games, such as video poker games, video blackjack games, video Keno, video bingo or any other suitable primary or base game may be implemented into the present invention. The additional independent games may also be of the same variety of wagering games. Combinations of independent games and primary and independent games may also constitute a new wagering configuration.

In one embodiment, as illustrated in FIG. 1, a base or primary game may be a slot game with one or more pay lines 52. The pay lines may be any portion of any horizontal, vertical, circular, diagonal, angled or any combination thereof. In this embodiment, the gaming device displays at least one and preferably a plurality of reels 54, such as three to five reels 54 in either electromechanical form with mechanical rotating reels or video form with simulated reels and movement thereof. In one embodiment, an electromechanical slot machine includes a plurality of adjacent, rotatable wheels which may be combined and operably coupled with an electronic display of any suitable type. In another embodiment, if the reels 54 are in video form, the plurality of simulated video reels 54 are displayed on one or more of the display devices as described above. Each reel 54 displays a plurality of indicia such as bells, hearts, fruits, numbers, letters, bars or other images which preferably correspond to a theme associated with the gaming device. In this embodiment, the gaming device awards prizes when the reels of the primary game stop spinning if specified types and/or configurations of indicia or symbols occur on an active pay line or otherwise occur in a winning pattern.

In one embodiment the player may select an additional game which is independent of the primary game place a wager on that additional game. In this embodiment the additional independent game consists of the appearance of adjoining symbols. The player is awarded the winning amount in accordance with the wager placed in the additional independent game. This independent game has its own pay table that is independent of the pay table of the primary game. The player may select to wager on either the primary game or the additional independent game or both.

In one embodiment, in addition to winning credits in a base or primary game, the gaming device may also give players the opportunity to win credits in a bonus or secondary game or bonus or secondary round. The bonus or secondary game enables the player to obtain a prize or payout in addition to the prize or payout, if any, obtained from the base or primary game. In general, a bonus or secondary game produces a significantly higher level of player excitement than the base or primary game because it provides a greater expectation of winning than the base or primary game and is accompanied with more attractive or unusual features than the base or primary game.

In one embodiment, the bonus or secondary game may be any type of suitable game, either similar to or completely different from the base or primary game. In one embodiment, the gaming device includes a program which will automatically begin a bonus round when the player has achieved a triggering event or qualifying condition in the base or primary game. In one embodiment, the triggering event or qualifying condition may be a selected outcome in the primary game or a particular arrangement of one or more indicia on a display device in the primary game, such as the number seven appearing on three adjacent reels along a pay line in the primary slot game embodiment seen in FIGS. 1. In another embodiment, the triggering event or qualifying condition may be by exceeding a certain amount of game play (number of games, number of credits, amount of time), reaching a specified number of points earned during game play or as a random award.

In one embodiment, once a player has qualified for a bonus game, the player may subsequently enhance his/her bonus game participation through continued play on the base or primary game. Thus, for each bonus qualifying event, such as a bonus symbol, that the player obtains, a given number of bonus game wagering points or credits may be accumulated in a “bonus meter” programmed to accrue the bonus wagering credits or entries toward eventual participation in a bonus game. The occurrence of multiple such bonus qualifying events in the primary game may result in an arithmetic or geometric increase in the number of bonus wagering credits awarded. In one embodiment, extra bonus wagering credits may be redeemed during the bonus game to extend play of the bonus game.

In one embodiment, no separate entry fee or buy in for a bonus game need be employed. That is, a player may not purchase an entry into a bonus game; he must win or earn entry through play of the primary game and, thus, play of the primary game is encouraged. In another embodiment, qualification of the bonus or secondary game could be accomplished through a simple “buy in” by the player if, for example, the player has been unsuccessful at qualifying through other specified activities.

In another embodiment four independent games are displayed on a gaming device. The player has the option to place wagers on one or more of the games with the wagers on each game being independent of the wagers of other games. The player also has the opportunity to wager on the on pay lines that transverse multiple games. For example he may place a wager on the appearance of a certain symbol at multiple locations in multiple games. To those familiar with the art the number of possible combinations of pay tables and games represent a very large possible number of game configurations.

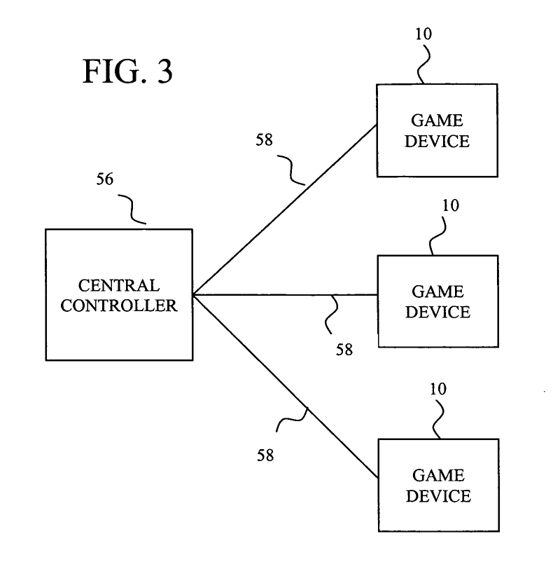

In one embodiment, as illustrated in FIG. 3, one or more of the gaming devices 10 of the present invention may be connected to each other through a data network or a remote communication link 58 with some or all of the functions of each gaming device provided at a central location such as a central server or central controller 56. More specifically, the processor of each gaming device may be designed to facilitate transmission of signals between the individual gaming device and the central server or controller.

In one embodiment, the game outcome provided to the player is determined by a central server or controller and provided to the player at the gaming device of the present invention. In this embodiment, each of a plurality of such gaming devices is in communication with the central server or controller. Upon a player initiating game play at one of the gaming devices, the initiated gaming device communicates a game outcome request to the central server or controller.

In a preferred embodiment of the invention includes an authentication method suitable for use in an operating system in an embedded gaming device. A user-space file system that can automatically authenticate its contents is provided. The user-space file system can be deployed on a standalone system or using a client-server model such that a remote system server can coordinate with a local client to perform authentication. By moving the authentication into the file system functional block there is additional assurance that any game code or data stored in the file system cannot be accessed without first performing the required authentication.

In one embodiment, the central server or controller receives the game outcome request and randomly generates a game outcome for the primary game based on probability data. In another embodiment, the central server or controller randomly generates a game outcome for the secondary game based on probability data. In another embodiment, the central server or controller randomly generates a game outcome for both the primary game and the secondary game based on probability data. In this embodiment, the central server or controller is capable of storing and utilizing program code or other data similar to the processor and memory device of the gaming device.

In an alternative embodiment, the central server or controller maintains one or more predetermined pools or sets of predetermined game outcomes. In this embodiment, the central server or controller receives the game outcome request and independently selects a predetermined game outcome from a set or pool of game outcomes. The central server or controller flags or marks the selected game outcome as used. Once a game outcome is flagged as used, it is prevented from further selection from the set or pool and cannot be selected by the central controller or server upon another wager. The provided game outcome can include a primary game outcome, a secondary game outcome, primary and secondary game outcomes, or a series of game outcomes such as free games.

The central server or controller communicates the generated or selected game outcome to the initiated gaming device. The gaming device receives the generated or selected game outcome and provides the game outcome to the player. In an alternative embodiment, how the generated or selected game outcome is to be presented or displayed to the player, such as a reel symbol combination of a slot machine or a hand of cards dealt in a card game, is also determined by the central server or controller and communicated to the initiated gaming device to be presented or displayed to the player. Central production or control can assist a gaming establishment or other entity in maintaining appropriate records, controlling gaming, reducing and preventing cheating or electronic or other errors, reducing or eliminating win-loss volatility and the like.

In another embodiment, one or more of the gaming devices of the present invention are in communication with a central server or controller for monitoring purposes only. That is, each individual gaming device randomly generates the game outcomes to be provided to the player and the central server or controller monitors the activities and events occurring on the plurality of gaming devices. In one embodiment, the gaming network includes a real-time or on-line accounting and gaming information system operably coupled to the central server or controller. The accounting and gaming information system of this embodiment includes a player database for storing player profiles, a player tracking module for tracking players and a credit system for providing automated casino transactions.

A plurality of the gaming devices of the present invention are capable of being connected together through a data network. In one embodiment, the data network is a local area network (LAN), in which one or more of the gaming devices are substantially proximate to each other and an on-site central server or controller as in, for example, a gaming establishment or a portion of a gaming establishment. In another embodiment, the data network is a wide area network (WAN) in which one or more of the gaming devices are in communication with at least one off-site central server or controller. In this embodiment, the plurality of gaming devices may be located in a different part of the gaming establishment or within a different gaming establishment than the off-site central server or controller. Thus, the WAN may include an off-site central server or controller and an off-site gaming device located within gaming establishments in the same geographic area, such as a city or state. The WAN gaming system of the present invention may be substantially identical to the LAN gaming system described above, although the number of gaming devices in each system may vary relative to each other.

In another embodiment, the data network is an internet or intranet. In this embodiment, the operation of the gaming device can be viewed at the gaming device with at least one internet browser. In this embodiment, operation of the gaming device and accumulation of credits may be accomplished with only a connection to the central server or controller (the internet/intranet server) through a conventional phone or other data transmission line, digital signal line (DSL), T-1 line, coaxial cable, fiber optic cable, or other suitable connection. In this embodiment, players may access an Internet game page from any location where an internet connection and computer, or other internet facilitators are available. The expansion in the number of computers and number and speed of internet connections in recent years increases opportunities for players to play from an ever-increasing number of remote sites. It should be appreciated that enhanced bandwidth of digital wireless communications may render such technology suitable for some or all communications according to the present invention, particularly if such communications are encrypted. Higher data transmission speeds may be useful for enhancing the sophistication and response of the display and interaction with the player.

In another embodiment, a plurality of gaming devices at one or more gaming sites may be networked to a central server in a progressive configuration, as known in the art, wherein a portion of each wager to initiate a base or primary game may be allocated to bonus or secondary event awards. In one embodiment, a host site computer is coupled to a plurality of the central servers at a variety of mutually remote gaming sites for providing a multi-site linked progressive automated gaming system. In one embodiment, a host site computer may serve gaming devices distributed throughout a number of properties at different geographical locations including, for example, different locations within a city or different cities within a state.

In one embodiment, the host site computer is maintained for the overall operation and control of the system. In this embodiment, a host site computer oversees the entire progressive gaming system and is the master for computing all progressive jackpots. All participating gaming sites report to, and receive information from, the host site computer. Each central server computer is responsible for all data communication between the gaming device hardware and software and the host site computer.

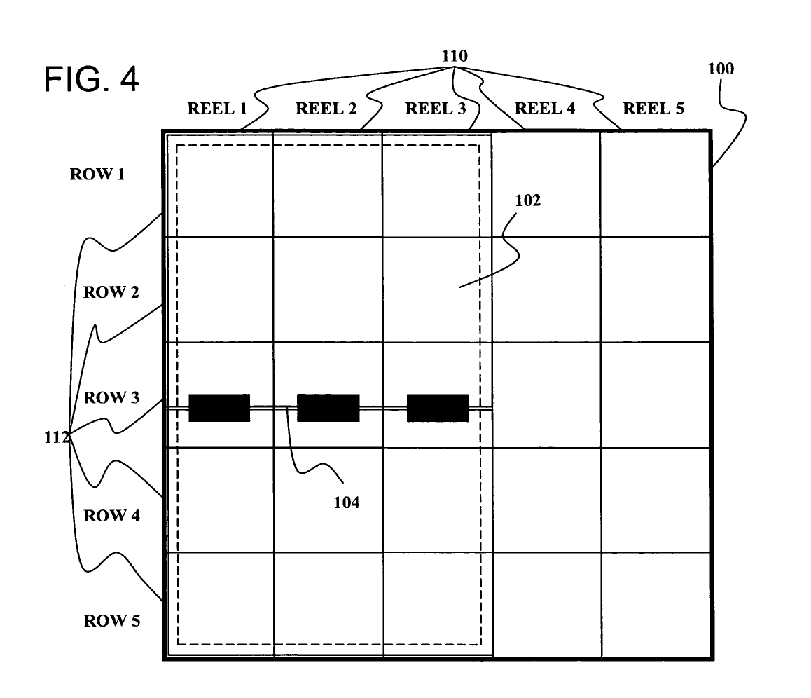

Referring now to FIG. 4, in one embodiment, the first combined multiple independent game set is a five reel video slot game 100 wherein the player wagers five credits per pay line in the first independent game unit which, in the illustrated embodiment, is predetermined by the game to be the maximum wager. In this embodiment of the present invention, the player can select the first independent game 102 and place a wager on selected pay lines. In this embodiment the first independent game consists of Reels 1, 2 and 3 and Rows 1, 2, 3, 4 and 5. In this example a winning combination of three symbols 104 is shown on Row 3. The player is awarded the winning amount in accordance with the wager placed in the first independent game. The first independent game has its own pay table.

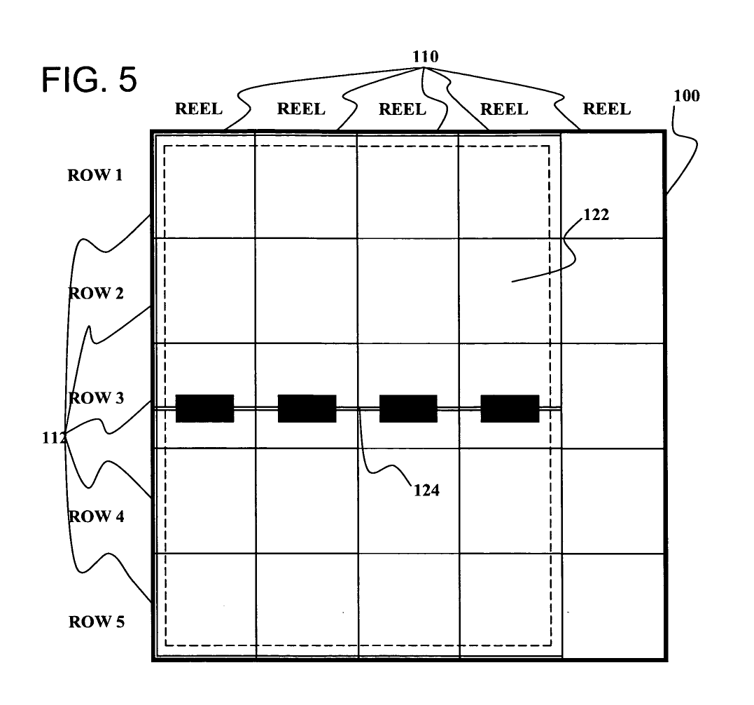

Referring now to FIG. 5, in another embodiment the player may also select an additional independent game 122 which is also a superset of the first independent game 102 and place a wager on selected pay lines. In this embodiment the independent game consists of Reels 1, 2, 3 and 4 and Rows 1, 2, 3, 4 and 5. In this example a winning combination of four symbols 124 is shown on Row 3. The player is awarded the winning amount in accordance with the wager placed in the additional independent game. This independent game 122 has its own pay table that is independent of the pay table of the first independent game 102. The player may also select to wager on the first independent game 102, shown in FIG. 4 and the additional independent game 122 or both.

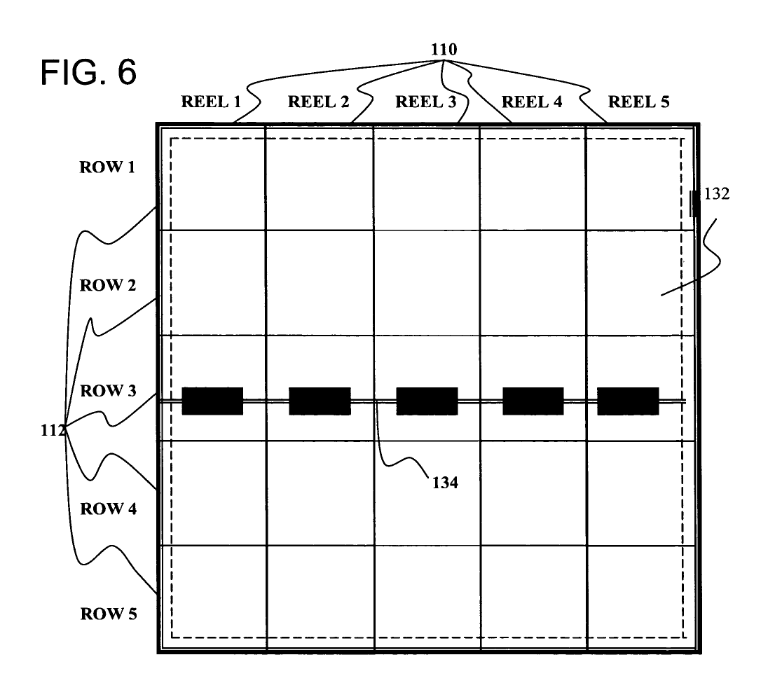

Referring now to FIG. 6, in another embodiment the player may also select another additional independent game 132, which is also an additional superset of the first independent game 102. In this embodiment the independent game consists of Reels 1, 2, 3, 4 and 5 and Rows 1, 2, 3, 4 and 5. In this example a winning combination of five symbols 134 is shown on Row 3. The player is awarded the winning amount in accordance with the wager placed in the additional independent game. This independent game 132 has its own pay table that is independent of the pay tables of the first independent game 102 or the first additional independent game 122. The player may also select to wager on the first independent game 102 shown in FIG. 4, the first independent game 122 shown in FIG. 5 or the second independent game 132 or any combination of all three.

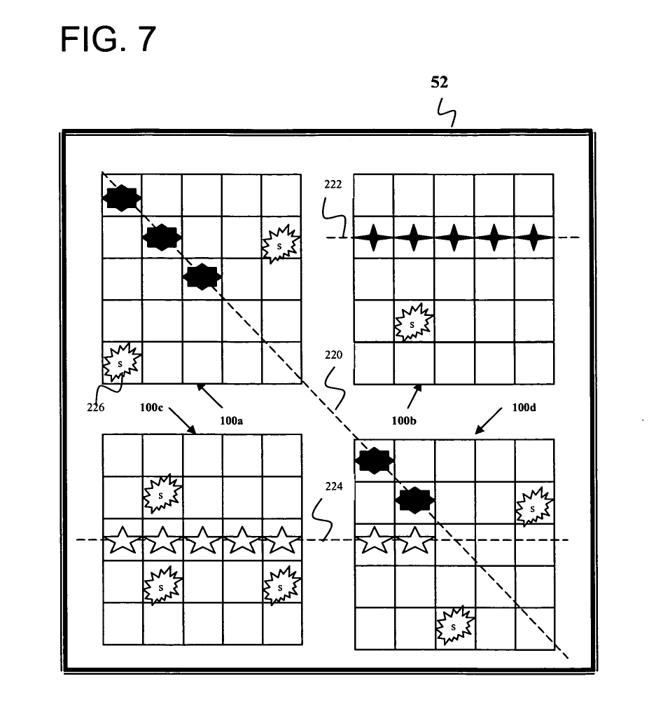

Referring now to FIG. 7 in one embodiment of the present invention, the player can make wagers on multiple independent games of the combined game set 100a, combined game set 100b, combined game set 100c and combined game set 100d. As in the embodiments described in FIGS. 4, 5, and 6 the player can wager on the first independent game 102 or any of the independent games, 122 and 132, as described in FIGS. 4, 5 and 6. An example of this is shown in combined game set 100b where the player is awarded the winning amount for five symbols for a wager on pay line 222.

Additionally, the player can wager on combinations of symbols in multiple combined game sets. In the embodiment shown in FIG. 7 the diagonal pay line 220 connects symbols in the upper left quadrant combined game set 100a with the symbols in the lower right quadrant combined game set 100d. In this example the player is awarded the winning amount of three symbols in combined game set 100a and the winning amount of two symbols in combined game set 100d and the winning amount of five symbols along the diagonal pay line 220.

In a similar fashion also shown in FIG. 7, a horizontal pay line 224 connects symbols in the lower left quadrant combined game set 100c with symbols in the lower right quadrant combined game set 100d. In this example the player is awarded the winning amount of five symbols in combined game set 100c and the winning amount of two symbols in combined game set 100d and the winning amount of seven symbols along the horizontal pay line 224.

In another embodiment of the feature shown in FIG. 7 a player that places wagers on all the combined game sets 100a, 100b, 100c and 100d will win when one or more scatter pay symbols 226 are displayed. It should be appreciated that any suitable number of types of games can be combined. It should also be appreciated that the independent games in a combined game set can be arranged in any number of ways by the implementer of the games. Further, multiple sets of combined games can also be arranged in any number of ways by the implementer of the games. It should also be appreciated that other types of games can be combined and features of those games enhanced for the benefit of the player.

It should be appreciated that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims

The invention is claimed as follows:

1. A gaming device operated under control of a processor, said gaming device comprising: a display device controlled by the processor; a plurality of areas displayed by the display device; and a plurality of fixed positions within each area, wherein the processor is operable to: (a) generate one of the plurality of symbols to be displayed by the display device at each of the fixed positions, and (b) provide an award for each winning combination of displayed symbols.

2. The gaming device of claim 1, wherein the areas include a set of positions for each of a plurality of independent games.

3. The gaming device of claim 1, which includes a plurality of reels which include symbols in an independent game.

4. The gaming device of claim 3, wherein at least one of the reels is an independent reel and wherein each of the independent reels is operable to generate one of the plurality of the symbols in an independent game.

5. The gaming device of claim 1, which includes a plurality of independent games which include symbols.

6. The gaming device of claim 5, wherein at least one of the independent games is a subset of another independent game and wherein each of the independent games has its own paytable associated with the plurality of the symbols.

7. The gaming device of claim 5, wherein at least one of the independent games is a superset of another independent game and wherein each of the independent games has its own paytable associated with the plurality of the symbols.

8. The gaming device of claim 1, wherein a set of the plurality of the symbols constitute a winning combination in each independent game.

9. The gaming device of claim 8, wherein multiple sets of the plurality of the symbols constitute winning combinations in the combined areas.

10. The gaming device of claim 8, wherein the fixed positions of each independent game is a matrix at least two rows and an equal or greater number of columns.

11. The gaming device of claim 1, wherein the processor is operable to make a determination of a winning combination of displayed symbols in each independent game.

12. A method of operating a gaming device, said method comprising at least: (a) multiple independent games within at least one area (b) each independent game displaying a plurality of fixed positions; (c) each independent game displaying one of a plurality of symbols at each of the plurality of displayed fixed positions, said symbols including at least one winning symbol; and (d) providing an award for at least each winning combination of displayed symbols of each independent game.

13. The method of claim 12, which include at least one additional independent game that is a subset of at least one other independent game.

14. The method of claim 12, which includes at least one additional independent game that is a superset of at least one other independent game.

15. The method of claim 12, which independent games are combined intra area to make additional independent games.

16. The method of claim 12, which independent games are combined inter areas to make additional independent games.

17. The method of claim 12, which includes generating the symbols on a plurality of reels.

18. The method of claim 12, which includes arranging the fixed positions in a matrix including a plurality of rows and a plurality of columns.

19. The method of claim 18, which includes a matrix for each independent game.

20. The method of claim 12, which includes determining any winning combination of displayed symbols in an independent game.

21. The method of claim 12, which includes determining of a winning combination of displayed symbols which is a set of the displayed symbols in an independent game.

22. The method of claim 12, which includes determining of a winning combination of displayed symbols which is a set of the displayed symbols in multiple independent games.

23. The method of claim 12, which includes determining a winning combination of displayed symbols which are multiple sets of the displayed symbols in an independent game.

24. The method of claim 12, which includes determining a winning combination of displayed symbols which are multiple sets of the displayed symbols in a plurality of independent games.

25. The method of claim 12, which includes determining a winning combination of displayed symbols upon a predetermined number of said displayed symbols in a plurality of independent games.

26. The method of claim 12, which includes determining a winning combination of displayed symbols upon a predetermined number of said displayed symbols in combined areas.

27. The method of claim 12, wherein the player places at least one wager on at least one of the independent games.

28. The method of claim 27, wherein, the player first places wagers in a required sequence on each independent game.

29. The method of claim 27, wherein, the player places a wager on each independent game in a required sequence.

30. The method of claim 27, wherein, the player places specified wagers on each independent game in a required sequence.

31. The method of claim 27, wherein, the player places a minimum wager on each independent game in a required sequence.

32. The method of claim 27, wherein, the player places maximum wagers on each independent game in a required sequence.

33. The game device of claim 32, wherein, the player places the maximum wager on each independent game in a required sequence before placing a wager on pay lines of multiple independent games in other areas.

34. The game device of claim 32, wherein, the player places the maximum wager on each independent game in a required sequence before placing a wager on pay lines of multiple independent games in other areas in a required sequence.

35. The method of claim 12, which is provided through a data network.

36. The method of claim 35, wherein the data network is an internet.
